(19) United States
(12) Patent Application Publication
(10) Pub. No.: US 2022/0020517 A1
(43) Pub. Date: Jan. 20, 2022

(54) CONVERTIBLE DEVICE ATTACHMENT/DETACHMENT MECHANISM

(71) Applicant: Lenovo (Singapore) Pte. Ltd., Singapore (SG)

(72) Inventors: Joseph Anthony Holung, Wake Forest, NC (US); Bouziane Yebka, Apex, NC (US); Joseph David Plunkett, Raleigh, NC (US); Philip John Jakes, Durham, NC (US); Tin-Lup Wong, Chapel Hill, NC (US)

(21) Appl. No.: 16/932,220

(22) Filed: Jul. 17, 2020

(51) Int. Cl. H01F 7/02; G06F 1/16; F16M 11/10

(52) U.S. Cl. CPC H01F 7/0242; F16M 11/10; H01F 7/0273; G06F 1/1669

(57) ABSTRACT

One embodiment provides a method, including: receiving, at an information handling device, an indication to transmit an electrical pulse to an electropermanent magnet; transmitting, responsive to the receiving and using a pulse transmitter, the electrical pulse to the electropermanent magnet; and affecting a magnetic field associated with the electropermanent magnet responsive to receiving the electrical pulse. Other aspects are described and claimed.

### BACKGROUND

The style and design of modern information handling devices (“devices”), for example convertible devices such as laptop computers, certain handheld gaming consoles, etc., provide users the flexibility to interact with and utilize these devices in a variety of different locations and ways. More particularly, certain device designs may allow users to attach one or more sections of the device together (e.g., a keyboard base section may be attached to a display section, etc.) and/or to detach these sections from one another.

### BRIEF SUMMARY

In summary, one aspect provides a method, comprising: receiving, at an information handling device, an indication to transmit an electrical pulse to an electropermanent magnet; transmitting, responsive to the receiving and using a pulse transmitter, the electrical pulse to the electropermanent magnet; and affecting a magnetic field associated with the electropermanent magnet responsive to receiving the electrical pulse.

Another aspect provides an information handling device, comprising: a pulse transmitter; a processor; a memory device that stores instructions executable by the processor to: receive an indication to transmit an electrical pulse to an electropermanent magnet; transmit, responsive to the receiving, the electrical pulse to the electropermanent magnet; and affect a magnetic field associated with the electropermanent magnet responsive to receiving the electrical pulse.

A further aspect provides a product, comprising: a storage device that stores code, the code being executable by a processor and comprising: code that receives an indication to transmit an electrical pulse to an electropermanent magnet; code that transmits, responsive to the code that receives, the electrical pulse to the electropermanent magnet; and code that affects a magnetic field associated with the electropermanent magnet responsive to receiving the electrical pulse.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of attaching and/or detaching sections of a device through use of a magnetic component.

FIG. 4. illustrates a convertible device attachment/detachment mechanism according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Manipulation of the sections of a convertible device allows users to utilize the device in the fashion that suits their contextual needs. For example, a user having a convertible laptop may substantially interact with their device in laptop mode throughout the workday. Once the user is finished working, they may convert their device to a tablet (e.g., by disconnecting the keyboard base section from the display section, etc.), which may provide them with greater interaction flexibility.

Conventional techniques for facilitating attachment and/or detachment of sections of a convertible device are largely mechanical in nature. Generally, attachment of one section to another (e.g., a tablet to a base, etc.) require a protruding portion of one section (e.g., a hook, etc.) to interact with a receptacle portion of the other section. Additionally, conventional designs also provide a way to lock/unlock these sections together when they are connected (e.g., via a spring, slider, muscle wire, switch, etc.). All of these additional components add complexity to the device operation and also produce an unattractive device appearance.

Accordingly, an embodiment provides a device with one or more magnetic components that enable a user to attach and/or detach certain sections of the device seamlessly. In an embodiment, an indication may be received by the device to transmit an electrical pulse to an electropermanent magnet housed in a section of the device. The indication may be derived from sensor data, active application data, switch data, a combination thereof, and the like. Responsive to receiving the indication, an embodiment may then transmit an electrical pulse to the electropermanent magnet, which may thereby affect an active state of a magnetic field associated with the electropermanent magnet. When the magnetic field is active and a magnetic portion of another section of the device is brought into proximity with a portion of the section housing the electropermanent magnet, the attractive forced produced by the active magnetic field may secure these two sections together. When the magnetic force is deactivated, the force is removed and the two sections may be separated. Such a method may provide for easy and attractive securement of device sections.

The illustrated example embodiments will be best understood by reference to the figures. The following description is intended only by way of example, and simply illustrates certain example embodiments.

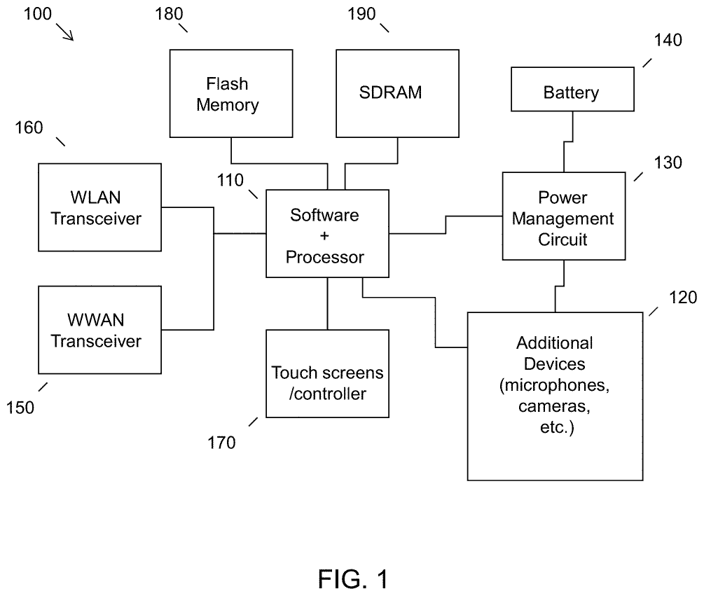

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

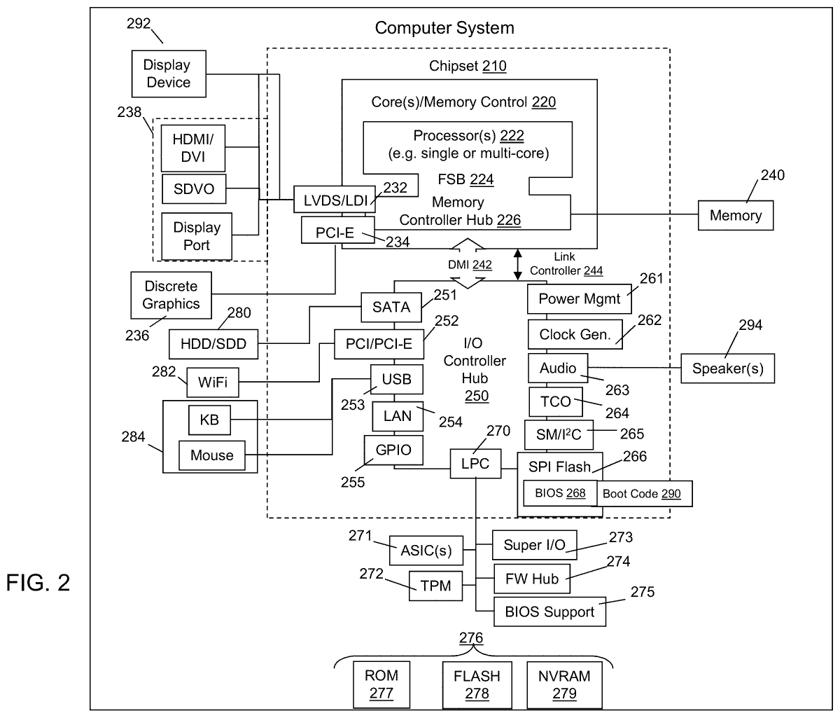

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface

(PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices having at least one electropermanent magnet that serves as a connecting mechanism. For example, the circuitry outlined in FIG. 1 may be implemented in a mobile handheld device, whereas the circuitry outlined in FIG. 2 may be implemented in a laptop computer.

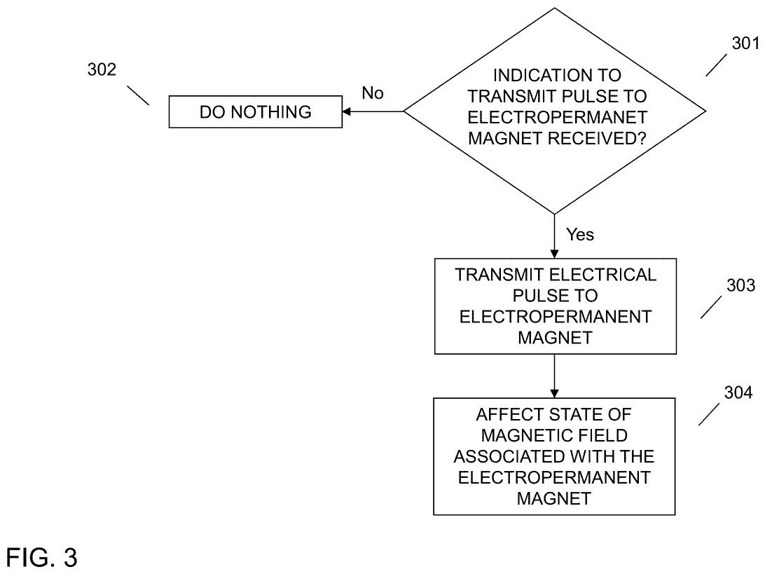

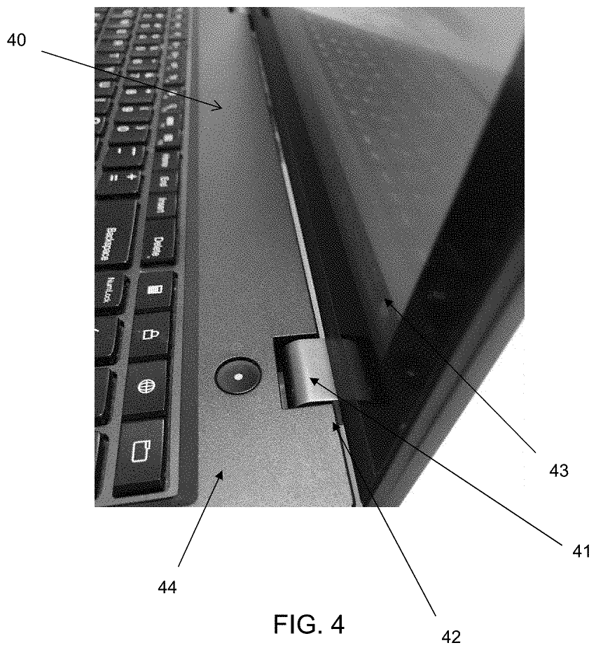

Referring now to FIG. 3, an embodiment provides a device having a magnetic component that can secure one or more other sections of the device. At 301, an embodiment may receive an indication to transmit an electrical pulse to an electropermanent magnet integrated into a portion of a section of the device. In an embodiment, the section may correspond to the base section of the device (i.e., the section comprising the processor, a keyboard, an input surface, etc.). Additionally, the portion at which the electropermanent magnet may be positioned on the base section may correspond to a positioning of a conventional securement mechanism. For example, the electropermanent magnet may be positioned on a back edge of the base section (i.e., the edge furthest away from the user). A non-limiting example illustration of the foregoing is provided in FIG. 4. A device 40 is provided that contains an electropermanent magnet 41 that is positioned at a back edge 42 of the device 40. The electropermanent magnet 41 may be used to secure a connecting section 43 of the device 40 to a base section 44.

In an embodiment, the electropermanent magnet may be configured to have a coil wound around it. When an electrical pulse is transmitted to the electropermanent magnet (e.g., via a pulse transmitter integrated into the device housing, etc.), the magnetic field surrounding the electropermanent magnet may be affected. More particularly, if inactive the magnetic field may be activated and if active the magnetic field may be deactivated. When the magnetic field is active, other metallic objects may be attracted to it and vice versa. The magnetic field may remain in a particular attractive state until another electrical pulse is received.

In an embodiment, the indication to transmit the electrical pulse to the electropermanent magnet may be derived from one or more data sources. For instance, sensor data may be used to dynamically identify when to turn the magnetic field on or off. Non-limiting examples of sensors that may produce relevant data include proximity sensors, camera sensors, audio sensors, a combination thereof, and the like.

In an embodiment, one or more proximity sensors may be utilized to detect when the two sections of the device are brought into proximity with one another. Responsive to determining that the sections are within a predetermined threshold distance of each other, an embodiment may provide an indication to transmit the electrical signal to the electropermanent magnet. Additionally or alternatively, an embodiment may utilize proximity sensors to determine when a user's hand is within a predetermined distance of a portion of a connected section (e.g., an embodiment may identify that a user's hand has approached a commonly grasped position on the connected section that is held when disconnecting the connected section from the base section, etc.). Such detection may provide an indication that the user desires to remove the connected section from the base section.

In an embodiment, one or more camera sensors (e.g., front-facing cameras, worldview cameras, etc.) integrated into one or more sections of the device may be utilized to determine when to transmit an electrical pulse. More particularly, one or more of the cameras may be always-on and may continually capture images and/or videos of user movement, device movement, etc., which may be analyzed in substantially real-time to determine whether a trigger indication is present. For example, an embodiment may identify that one section of the device is moving toward another section. Such a detection may provide an indication that a user wishes to connect the two sections together. Additionally or alternatively, an embodiment may track user movements to determine whether a user has performed a movement that may be indicative of their intention to separate the device sections (e.g., an embodiment may determine that a user is moving their hand toward a commonly grasped position on the connected section that is held when disconnecting the two sections from one another, etc.).

In an embodiment, one or more audio sensors (e.g., always-on microphones, etc.) may be utilized to detect situations in which a user has provided some audible indication that they desire to separate or attach the sections. For example, the audible indication may be an explicit audible command to separate the sections. As another example, the audible indication may be more contextual in nature. More particularly, an embodiment may record and subsequently analyze a user's speech to determine whether they have indicated an intent to attach or separate the sections. For example, a user may provide an indication in a conversation they are having with another individual of their intent to separate the sections (e.g., “I'm going to watch that movie on my tablet”, etc.).

Another data source that may be utilized to determine whether an indication was received is active application data. As used herein, active application data may refer to a top level application a user is interacting with. An embodiment may receive an indication of this application and may thereafter determine, from this knowledge, whether to transmit an electrical pulse to the electropermanent magnet. For example, responsive to determining that a word processing application is being interacted with, an embodiment may receive an indication to transmit an electrical pulse to the electropermanent magnet to activate the magnetic field. Such an indication may be transmitted based upon a device's knowledge that the user, or a crowdsourced group of users, prefers to interact with word processing applications in laptop mode. Alternatively, as another example, responsive to determining that a video streaming application is active, an embodiment may receive an indication to transmit an electrical pulse to the electropermanent magnet to deactivate the magnetic field. Such an indication may be transmitted based upon a device's knowledge that the user, or a crowdsourced group of users, prefers to watch videos on their device in tablet mode.

Yet another data source that may be utilized to determine whether an indication was received is switch data. More particularly, a switch may exist on the device (e.g., a physical switch, a virtual switch displayed on a display screen of the device, etc.) that a user may toggle when they want to adjust the magnetic field. Responsive to detecting that a user has flipped the physical or virtual switch, an embodiment may transmit an electrical pulse to the electropermanent magnet.

An embodiment may require that a supporting force be detected on the connecting section prior to disabling the magnetic field. More particularly, if the attractive force between the two sections is disabled and the connecting section has no support, then that section may simply fall down, potentially causing harm to the connecting section. Accordingly, an embodiment may utilize one or more of the aforementioned types of sensor data or use additional data (e.g., pressure sensor data, etc.) in making this determination. An example of a supporting force that may be detected and that may subsequently authorize deactivation of the magnetic field is a user's grasping of the connecting section with their hand. Additionally to the foregoing, an embodiment may require that the supportive force be detected for a predetermined period of time (e.g., 3 seconds, 5 seconds, 10 seconds, etc.) prior to deactivating the magnetic field.

Responsive to not receiving, at 301, an indication to transmit an electrical pulse, an embodiment may, at 302, take no additional action. Conversely, if an indication is received, at 301, to transmit an electrical pulse, an embodiment may, at 303, transmit the electrical pulse to the electropermanent magnet via a pulse transmitter. Receipt of the pulse at the electropermanent magnet may adjust the polarity of the electropermanent magnet, which may correspondingly affect, at 304, an attractive state of the magnetic field, as previously described above. If the magnetic field was originally off, receipt of the pulse may therefore activate the magnetic field and vice versa. Through the activation and deactivation of the magnetic field, an embodiment may secure two sections together or detach them from one another.

It is important to note that although the foregoing disclosure was described primarily in relation to convertible devices, specifically laptops, handhelds, etc., such a designation is not limiting. More particularly, the magnetic attachment/detachment mechanism described above may be utilized in virtually any device/object containing two or more sections that need to be secured together. For example, the concepts described above may be implemented into kitchen appliances, cabinetry, furniture, other devices and/or objects, etc.

The various embodiments described herein thus represent a technical improvement to conventional methods for attaching and/or detaching two or more sections of a device. Using the techniques described herein, an embodiment may receive an indication to transmit an electrical pulse to an electropermanent magnet. The indication may be derived from one or more different data sources such as sensor data, active application data, switch toggle data, etc.) Responsive to receiving the indication, an embodiment may transmit the electrical pulse to the electropermanent magnet, which may thereby affect an attractive state of the magnetic field surrounding the electropermanent magnet. For example, the electrical pulse may cause the magnetic field to activate or deactivate, which may influence the ability of the electropermanent magnet to secure other metallic objects (e.g., such as a connecting section of a device, etc.). Such an embodiment may optimize the way in which users manipulate their convertible devices from one mode to another.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to transmit an electrical pulse to an electropermanent magnet;
transmitting, responsive to the receiving and using a pulse transmitter, the electrical pulse to the electropermanent magnet; and
affecting a magnetic field associated with the electropermanent magnet responsive to receiving the electrical pulse.

2. The method of claim 1, wherein the receiving the indication comprises receiving the indication from sensor data.

3. The method of claim 2, wherein the sensor data is obtained by at least one sensor selected from the group consisting of a proximity sensor, a camera sensor, and an audio sensor.

4. The method of claim 1, wherein the receiving the indication comprises receiving the indication from active application data.

5. The method of claim 1, wherein the receiving the indication comprises receiving the indication from a manually toggled switch.

6. The method of claim 1, wherein the affecting the magnetic field comprises activating the magnetic field.

7. The method of claim 6, wherein the activating comprises securing another section of the information handling device to a section housing the electropermanent magnet.

8. The method of claim 7, wherein a portion of the another section interacting with the electropermanent magnet is composed of a magnetic material.

9. The method of claim 1, wherein the affecting the magnetic field comprises deactivating the magnetic field.

10. The method of claim 1, wherein the affecting comprises automatically affecting the magnetic field without any additional user input.

11. An information handling device, comprising:
a pulse transmitter;
a processor;
a memory device that stores instructions executable by the processor to:
receive an indication to transmit an electrical pulse to an electropermanent magnet;
transmit, responsive to the receiving, the electrical pulse to the electropermanent magnet; and
affect a magnetic field associated with the electropermanent magnet responsive to receiving the electrical pulse.

12. The information handling device of claim 11, wherein the instructions executable by the processor to receive the indication comprise instructions executable by the processor to receive the indication from sensor data.

13. The information handling device of claim 2, wherein the sensor data is obtained by at least one sensor selected from the group consisting of a proximity sensor, a camera sensor, and an audio sensor.

14. The information handling device of claim 11, wherein the instructions executable by the processor to receive the indication comprise instructions executable by the processor to receive the indication from active application data.

15. The information handling device of claim 11, wherein the instructions executable by the processor to receive the indication comprise instructions executable by the processor to receive the indication from a manually toggled switch.

16. The information handling device of claim 11, wherein the instructions executable by the processor to affect the magnetic field comprise instructions executable by the processor to activate the magnetic field.

17. The information handling device of claim 16, wherein the instructions executable by the processor to activate comprise instructions executable by the processor to secure another section of the information handling device to a section housing the electropermanent magnet.

18. The information handling device of claim 17, wherein a portion of the another section interacting with the electropermanent magnet is composed of a magnetic material.

19. The information handling device of claim 11, wherein the instructions executable by the processor to affect the magnetic field comprise instructions executable by the processor to deactivate the magnetic field.

20. A product, comprising:
a storage device that stores code, the code being executable by a processor and comprising:
code that receives an indication to transmit an electrical pulse to an electropermanent magnet;
code that transmits, responsive to the code that receives, the electrical pulse to the electropermanent magnet; and
code that affects a magnetic field associated with the electropermanent magnet responsive to receiving the electrical pulse.
